(19) United States
(12) Patent Application Publication
(10) Pub. No.: US 2005/0016038 A1
(43) Pub. Date: Jan. 27, 2005

(54) Commercial magnetic flexible multi-colored exterior neon lighting

(76) Inventor: Fredrick Gober, Jonessboro, GA (US)

Correspondence Address: FREDRICK GOBER, 675 CHATHAM TRAIL, JONESBORO, GA, 30238, US

(21) Appl. No.: 10/762,999

(22) Filed: Jun. 15, 2004

Related U.S. Application Data
(60) Provisional application No. 60/457,364, filed on Mar. 26, 2003.

(51) Int. Cl. G09F 21/04

(52) U.S. Cl. 40/591

(57) ABSTRACT

MULTI-COLORED NEON LIGHTING WILL BE USED FOR ALERTNESS ON STATE HIGH WAYS AND LOCAL STREETS DAY OR NIGHT. THIS DEVICE WILL ALSO BE AN ASSET FOR BOATS, TRAILERS IN TOW AND LAWN & GARDEN EQUIPMENT. THE NEON LIGHTING DEVICE ATTACHED TO VARIOUS VEHICLES AND EQUIPMENT WILL IMPROVE SAEFTY ON TRAVELING HIGHWAYS IN ALL TYPES OF WEATHER FOR BETTER VISIBILITY

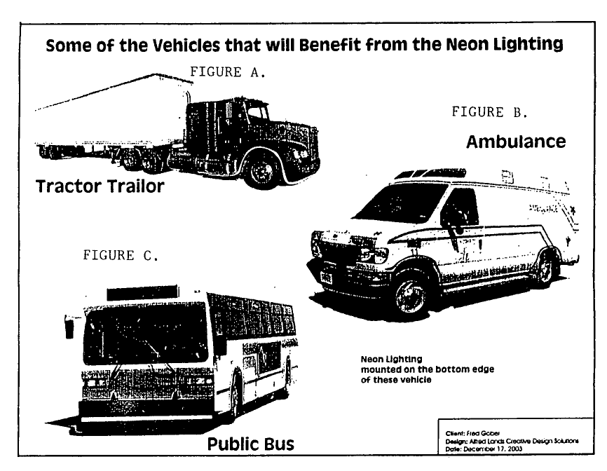

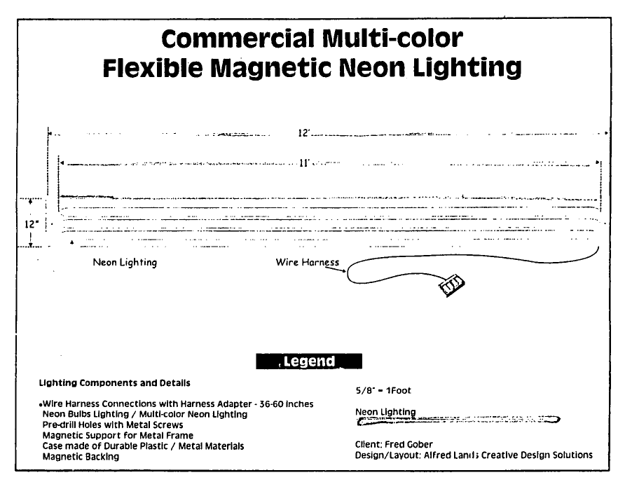

Exterior lighting will be sold in lengths varying from 3 feet to 35 feet. This product will be available for small, medium, large, and heavy-duty commercial vehicles. It will also be an asset for boats, trailers in tow, and lawn and garden equipment. It will be useful in both highway and local usage. Wire harness will be equipped for multi-use power sources.

### PURPOSE

The ultimate purpose of this product is to improve the safety of those traveling on our highways, and local streets, and to prevent as many accidents as possible.

### EXPLANATION

The commercial magnetic flexible multi-colored exterior neon lighting will be most beneficial in preventing accidents involving personal vehicles and commercial vehicles such as tractor trailers, buses used for public/private transportation, and emergency vehicles as well. This product will be beneficial in all weather types including fog and rainy weather. It will be available in flexible lighting as well as standard fender side railing. Also all around trailers-taillights, and side-lighting.

The inspiration for this product came after much thought and experience with accidents, and near accidents, which seemed to have had the possibility of being prevented had there been proper or additional lighting on the commercial vehicles involved. Most of these incidents occurred at night, which is a time when they are not as visible. Using commercial exterior neon lighting will insure, better visibility for vehicles coming in contact with commercial vehicles, therefore reducing the number of accidents, and traffic fatalities.

1. THE MAGNETIC LIGHTING DEVICE PLUGS INTO A HARNESS SENDING ELECTRICITY TO ACTIVATE NEON LIGHTS TO INSURE VISIBILITY THE LIGHTS IMPROVES SAFETY ON HIGHWAYS AND LOCAL STREETS. THIS DEVICE WILL BE ESPECIALLY BENEFICIAL ON FOGGY, RAINY WEATHER DAY OR NIGHT.
